(19) United States
(12) Patent Application Publication
(10) Pub. No.: US 2007/0240018 A1
(43) Pub. Date: Oct. 11, 2007

(54) Functional level reset on a per device/function basis

(75) Inventors: Rajeev Nalawadi, Folsom, CA (US); Balaji Vembu, Folsom, CA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/323,297

(22) Filed: Dec. 29, 2005

(51) Int. Cl. G06F 11/00

(52) U.S. Cl. 714/23

(57) ABSTRACT

A device within a system, or an individual function of the device, may be reset to a known state while all other devices in the system or other functions of the device that are not being reset remain operational.

### FIELD OF THE INVENTION

Embodiments of the present invention relate to input/output (I/O) devices and more specifically to the ability to reset a single device or a single function of a device in a system without affecting other devices or functions of the device in the system.

### BACKGROUND

In current operating environments, device reset and recovery for a hung or non-functional peripheral component interconnect (PCI), PCI-X, or PCI-Express device is closely tied to platform reset or secondary bus reset (SBR) mechanisms which affect all or many devices in the platform hierarchy. Thus, when a single device requires a reset, multiple downstream ports are disrupted. Furthermore, if the device to be reset is not behind a bridge or switch, only a platform reset will bring a hung or non-functional device into a functional state.

### BRIEF DESCRIPTION OF THE DRAWINGS

A better understanding of embodiments of the present invention can be obtained from the following detailed description in conjunction with the following drawings, in which:

FIG. 1 is a conceptual illustration of a system block diagram according to some embodiments.

FIG. 2 is a block diagram illustrating a multi-function device that is capable of a functional level reset (FLR) according to some embodiments.

FIG. 3 is a flow diagram illustrating a functional level reset (FLR) according to some embodiments.

FIG. 4 is a state diagram illustrating device state transitions according to some embodiments.

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed. In other instances, well known structures and devices are shown in block diagram form, rather than in detail.

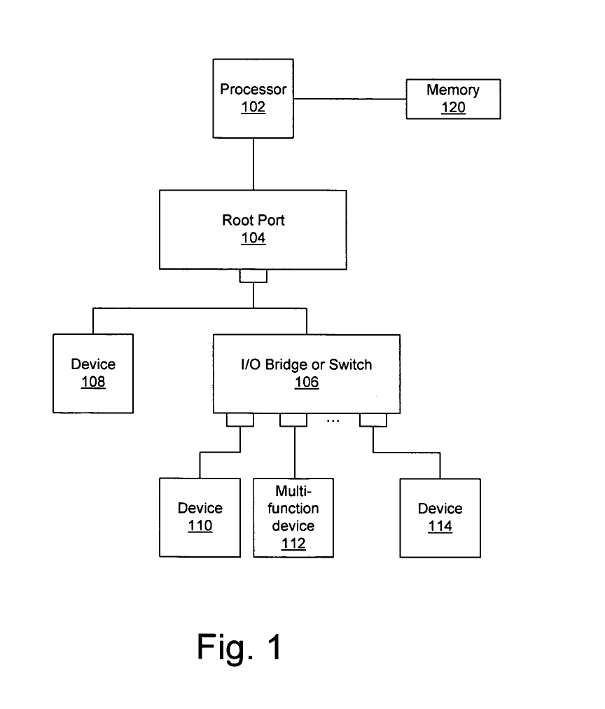

FIG. 1 is a block diagram of a computer system according to some embodiments. A processor (102) is coupled to a root port (104). In some embodiments, one or more root ports may be included within another device, such as an I/O Controller Hub (ICH).

The root port may be further coupled to an I/O bridge or switch (106) and one or more devices (108). The I/O bridge or switch (106) may be coupled to multiple devices (110, 112, 114). The system may be configured in many ways, with more or fewer devices, I/O bridges, or switches, each of which may be connected to the root port (104) or to another port in the system.

Devices 108, 110, 112, and 114 may be PCI devices, PCI-X devices, PCI-X to PCI Express bridges, PCI Express to PCI-X bridges, Root Complex Integrated Endpoint devices, PCI Express root ports, legacy PCI Express endpoint devices, PCI Express endpoint devices, or another type of PCI, PCI-X, or PCI Express I/O device. Each device may be a single function device, or may be a multi-function device. For example, device 110 may be a single function device, while device 112 is a multi-function device.

The PCI, PCI-X, and PCI Express interfaces are described in the following specifications: the Peripheral Chip Interconnect (PCI) Local Bus Specification, rev. 3.0, dated Feb. 3, 2004, by the PCI Special Interest Group (SIG); the PCI Express™ Base Specification rev. 1.1, dated Mar. 28, 2005, by the PCI SIG; and the PCI-X Protocol Addendum to the PCI Local Bus Specification rev. 2.0a, dated Jul. 22, 2003 by the PCI SIG. Embodiments of the invention may be expanded to future revisions and generations of PCI, PCI-X, PCI Express, and other PCI-related specifications and devices.

The system may include more or fewer root ports, single or multi-function devices, I/O bridges and/or switches than are shown in the example of FIG. 1. These components may also be configured in a different manner than is shown in the example.

The system may also include other components. Memory (120) may be coupled to the processor (102) to store software. The memory may be system memory, or may be a hard disk drive or another type of memory device. In some embodiments, the memory (120) may be coupled to the processor through a memory controller hub device, which may be integrated as part of the processor, or may be included in a separate chipset device.

According to some embodiments, when a device or one function of a multi-function device is hung or non-functional, a functional level reset operation may be initiated using software to dynamically reset the hung device/function without disrupting the performance of other functions in the device or other devices in the system. No device specific driver is required for a functional level reset operation. The term “device/function” is used herein to mean either a device in a system or one function of a multi-function device.

For example, if device 108 is hung or non-functional, a functional level reset operation will allow device 108 to become fully operational without affecting operation of the root port (104), I/O bridge/switch (106) or other devices (110, 112, 114) in the system. Furthermore, if a single function of a multi-function device (112) is hung or non-functional, a functional level reset of the hung function will allow that function to become fully operational without affecting the other functions within the multi-function device (112) or other devices in the system. When a functional level reset is initiated on a specific function of a multi-function device, all other functions in the device will continue to be operational and are not affected by the functional level reset operation.

If the hung function or device is not accessible via software due to a malfunction of the root port, I/O bridge, or switch device, it may be necessary to perform a functional level reset on the malfunctioning device as well. System software may manage this process by continuing to progress upwards in the hierarchy from a device (110) to the I/O bridge/switch (106), and finally to the root port (104), exercising the functional level reset operation on one device/function at a time until all devices in the system are operating properly. The system software may be a virtualization layer between hardware and, such as, but not limited to, a virtual machine monitor (VMM).

In another embodiment, a functional level reset operation may be invoked in a partitioned environment where hardware is migrated from one partition to another. Thus, a device/function may be reset upon migration to ensure that no residual knowledge of the prior partition is retained within the hardware. During the functional level reset of the migrated device/function, all other devices/functions in the system remain operational.

Not all devices/functions in a system may support the functional level reset operation. Software may determine which device(s) support the functional level reset by using a look up table or other list of devices. Software may also determine if a device is capable of supporting a functional level reset by reading the device's capability registers. In some embodiments, the look up table or list may be stored in memory (120). The list or table may be updated each time the system is reset or each time a new device/function is added to or removed from the system. In some embodiments, this list may be stored in a register, and the register may be parsed to determine if the device/function is capable of undergoing a functional level reset.

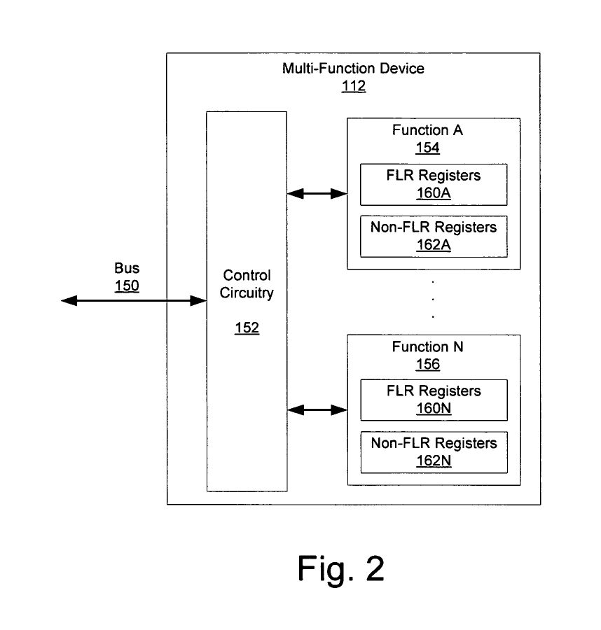

FIG. 2 is a block diagram of a multi-function device according to some embodiments. The multi-function device (112) may include two or more functions, such as Function A (154) and Function N (156).

The multi-function device includes control circuitry (152) which may receive commands from software via a bus (150). The bus may be a PCI, PCI-X, or PCI-Express bus in some embodiments. The control circuitry may include one or more application PCI bridges to process transactions for each function of the multi-function device.

Each function (154, 156) of the multi-function device (112) has associated registers. Each function may have registers that are cleared or reset to known default values during a functional level reset operation, such as FLR registers (160A, 160N). Each function may also have registers that are not modified during a functional level reset operation, such as non-FLR registers (162A, 162N). FLR registers (160A, 160N) may include some or all of the function's device-class specific and generic registers. Non-FLR registers (162A, 162N) may include some or all registers that are BIOS programmed and/or control the overall platform behavior. The non-FLR (162A, 162N) registers may not be cleared when a functional level reset is initiated. Non-FLR registers may include, but are not limited to, BIOS programmed registers for storage controllers & USB controllers.

Thus, when a functional level reset operation is initiated on Function A (154), the function may enter a functional level reset state and clear all FLR registers (160A) to default values. The function's non-FLR registers (162A) may not be modified. While Function A (154) is undergoing a functional level reset operation, Function B (156) remains operational, and is able to transmit and receive commands and data via the control circuitry (152) and bus (150).

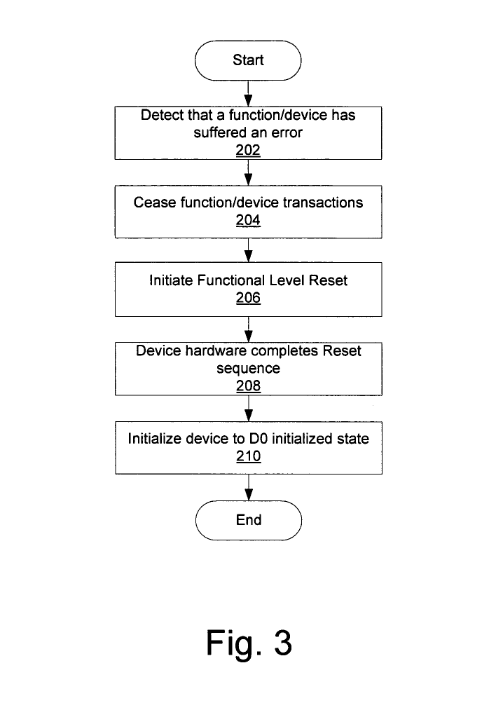

FIG. 3 is a flow chart illustrating operation of the functional level reset mechanism according to some embodiments. In one embodiment, software detects when a device or a function of a multi-function device has suffered an error (202) and thus requires a reset. The device/function may be hung, or may be non-functional for another reason. In the same or another embodiment, the system may detect that a device/function has been migrated from one partition to another and requires a functional level reset.

Prior to initiating the functional level reset operation, the system software may attempt to ensure that there are no outstanding transactions for the device/function that will be undergoing the reset (204).

If there is a device driver present, the system software may invoke steps similar to that for a hot-plug orderly removal, stopping all incoming and outgoing transactions and performing any other tasks that may be required before the device/function can be reset. If no device driver is present, the system software may follow generic steps on the device hardware using control bits in a PCI, PCI-X or PCI Express command register, such as Bus Master Enable, SERR Enable, Interrupt Disable, MSI/MISX Enable, PME Enable, or other control bits which are architecturally defined. This will ensure that the device is blocked from generating new requests during the functional level reset operation.

Next, system software invokes a functional level reset of the device/function that has suffered an error (206). The functional level reset operation may be initiated by writing a value to a bit in a configuration space.

When one function of a multi-function device is undergoing a functional level reset, the external pin interfaces of the device will not be affected by the device/function undergoing the state transition. Thus, the other functions of the device remain active during the functional level reset of a single function.

Once the functional level reset is initiated, the device hardware transitions from its current state into the functional level reset state. While the device is undergoing the functional level reset and is in the functional level reset state, all cycles (configuration space access, I/O, memory) targeting its interface are discarded. As a result, the requestor of any discarded cycles may not receive a completion for its request. Thus, the requester's completion timeout mechanism is expected to terminate the request. In some embodiments, the minimum time for expiration may not be less than 10 ms, and the maximum time may be 50 ms. The device hardware may delay the exit from the functional level reset state to ensure that all outstanding requests have been flushed.

A memory read request for which there are multiple completions must be considered completed only when all completions have been received by the requester. If some, but not all requested data has been returned before the software initiates a functional level reset, the completion timeout timer may expire. The requestor is permitted to keep or to discard the data that was returned prior to timer expiration.

Completion of the functional level reset (208) occurs when the device/function is able to accept and respond to a valid configuration space request. When the device/function accepts and responds to a configuration space request from system software, the device enters the D0 uninitialized state. In some embodiments, the device/function may complete the reset transition within 100 ms. Thus, system software must wait at least 100 ms after initiating a functional level reset for a device/function to be capable of accepting configuration space requests.

The device may respond only to configuration space cycles until the system software enables the memory/IO/interrupt resources for decoding. In some embodiments, some devices may require more than 100 ms to complete the self initialization sequence. This temporary inability to process a request may be conveyed by the device hardware using the Configuration Request Retry Status (CRS) Completion Status.

In some embodiments, software may issue a configurations space read request as the first cycle after a functional level reset to check for successful completion of the reset cycle.

Once the device/function has successfully completed the functional level reset and is responding to configuration space read requests, the software may then transition the device/function from the D0 uninitialized state to the D0 initialized state (210).

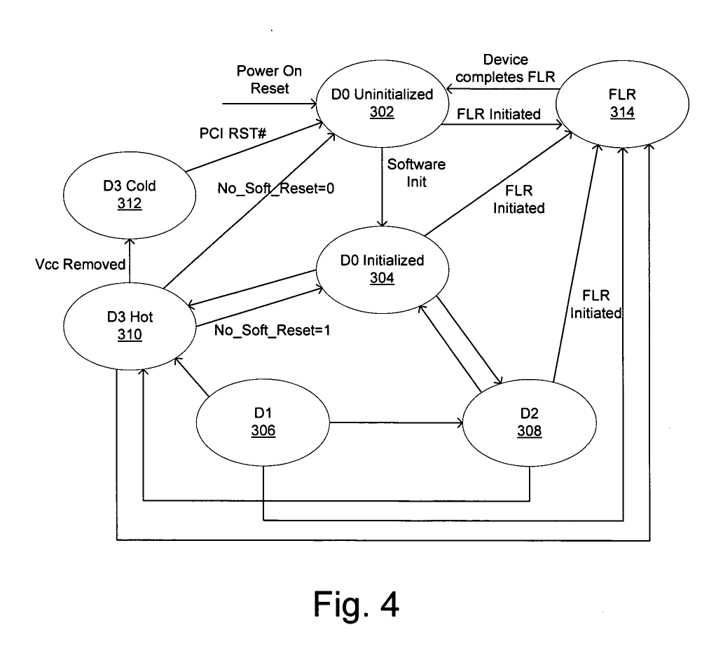

FIG. 4 illustrates the possible device states and state transitions with respect to the functional level reset state described herein. The device states include D0 Uninitialized (302), D0 Initialized (304), D1 (306), D2 (308), D3 Hot (310), D3 Cold (312), and Functional Level Reset (FLR) (314).

Upon power on reset, the device/function enters the D0 Uninitialized state (302). Software may initialize the device/function to place it in the D0 Initialized state (304). From the D0 Initialized state (304), the device may enter the D1 (306), D2 (308), or D3 Hot (310) states. If the device is in the D3 Hot state (310) and power is removed from the device, the device will enter the D3 Cold state (312). The device may enter the Functional Level Reset state (314) from the D0 Uninitialized state (302), the D0 Initialized state (304), and the D1 (306), D2 (308), or D3 Hot (310) states.

Software may initiate the transition into the FLR state (314). This may be done by writing a value to a memory location. For example, the functional level reset sequence may be initiated by setting an “Initiate FLR” bit in the device/function configuration space. While in the FLR state, the device/function stops all bus mastering activity, clears all pending interrupts or other pending transactions, and stops generating any future interrupts. The device/function may also stop decoding I/O and memory resources that have been assigned to the device by previously running software, and may stop responding to any external I/O or memory transactions and configuration space cycles.

The device/function may also reset all device-class specific and generic registers to their default values. However, some of the registers that are BIOS programmed and control the overall platform behavior are typically programmed only once during the boot-up phase and may not be cleared when FLR is initiated. For example, the way the SATA (storage) controllers & USB controllers are configured may not be affected by FLR.

During FLR, all states previously initialized by software are cleared, and all pending power management events (PMEs) are cleared. The device also clears all pending errors. Some errors may be saved to enable error logging, depending on the device class/type requirements. If a built in self-test (BIST) sequence is in progress, the device may interrupt the BIST sequence to proceed with the FLR state transition.

The device will continue to receive power in the FLR state, and any functions not undergoing FLR will remain functional. Upon completion of the FLR state behaviors, the device/function will exit the FLR state (314) and enter the D0 Uninitialized state (302). From a system perspective, this reflects the same behavior as if the device were to lose power and subsequently have power reapplied to the device.

Table 1, below, illustrates the device state transition table definitions for transitions between each state and the functional level reset state.

TABLE 1
Device State Definitions

| Present | Next Device | |
|---|---|---|
| Device State | State | Expected Behavior Definitions |
| D0 | Functional | Software maintains a list of devices |
| Initialized | Level Reset | that support the functional level |
| State (304) | State | reset feature as part of discovery |
| | | and initialization phase. |
| | | Software determines that a device |
| | | has to go through a functional level |
| | | reset operation while the system is |
| | | running |
| | | Software initiates the functional |
| | | level reset sequence on the device |
| | | by writing to configuration space |
| | | Hardware stops responding to all |
| | | cycles targeting the device/function |
| | | while undergoing the functional |
| | | level reset |
| Functional | D0 | Hardware determines that it has |
| Level Reset | uninitialized | completed the functional level reset |
| State (314) | State | & has reset the device class/type |
| | | specific registers |
| | | Device responds to ONLY configuration |
| | | space accesses from the host in the |
| | | D0 uninitialized state till software |
| | | reinitializes all the IO/Memory/ |
| | | Interrupt resources that need to be |
| | | consumed by the device & enables the |
| | | decode of the device for runtime |
| | | functionality |
| D0 Unini- | Functional | Device may have been in idle/unused |
| tialized | Level Reset | state for a longer time and software |
| State (302) | State | determines the need to initiate a |
| | | functional level reset operation |
| | | Software initiates the functional |
| | | level reset sequence on the device |
| | | by writing to configuration space |
| | | Hardware stops responding to all |
| | | cycles targeting the device/function |
| | | while undergoing the functional |
| | | level reset |
| D1 (306), | Functional | While device is in D1, D2, D3hot |
| D2 (308), | Level Reset | state it can undergo a DQR state |
| D3Hot (310) | State | transition when the software uses |
| State | | the “Initiate DQR” bit to |
| | | start the sequence |
| D3 Hot | D0 Initialized | While Device is D3hot state it can |
| State (310) | State transition | also be transitioned to D0 Initialized |
| | followed by | state by software prior to initiating |
| | entry to | the Functional Level Reset sequence. |
| | Functional | This requires a two-step process. |
| | Level Reset | |
| | State | |
| D3 Hot | D0 | While Device is D3hot state it can |
| State (310) | Uninitialized | also be transitioned to D0 Uninitialized |
| | State transition | state by software prior to initiating |
| | followed by | the Functional Level Reset sequence. |
| | entry to | This is a two-step process. |
| | Functional | |
| | Level Reset | |
| | State | |
| D3 Cold | D0 | While Device is D3cold state it can be |
| State (312) | Uninitialized | transitioned to D0 Uninitialized state |
| | State transition | by hardware (reset) prior to initiating |
| | followed by | the Functional Level Reset sequence. |
| | entry to | This is a two-step process. |
| | Functional | |
| | Level Reset | |
| | State | |

The methods set forth above may be implemented via instructions stored on a machine-accessible medium which are executed by a processor. The instructions may be implemented in many different ways, utilizing any programming code stored on any machine-accessible medium. A machine-accessible medium includes any mechanism that provides (i.e., stores and/or transmits) information in a form readable by a machine, such as a computer. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

Thus, a method and system for providing a functional level reset are disclosed. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method comprising:
determining that a first function of a multi-function device requires a reset; and
initiating the reset of the first function of the multi-function device, wherein a second function of the multi-function device remains operational during the reset.

2. The method of claim 1, wherein initiating the reset comprises writing a value to a memory location.

3. The method of claim 1, further comprising transitioning the first function into an uninitialized state.

4. The method of claim 3, wherein transitioning the first function into the uninitialized state occurs less than 100 ms after initiating the reset.

5. The method of claim 3, wherein transitioning the first function into an uninitialized state comprises at least clearing pending transactions, ceasing bus mastering activity, and resetting device registers to default values.

6. The method of claim 5, further comprising transitioning the first function into an initialized state.

7. The method of claim 1, further comprising determining whether the first function is capable of undergoing a functional level reset.

8. The method of claim 7, wherein determining whether the first function is capable of undergoing a functional level reset comprises parsing a register.

9. A system, comprising:
a root port;
a first device coupled to the root port;
a second device coupled to the root port, wherein the first device is capable of being reset while the second device remains operational.

10. The system of claim 9, wherein the first device has a first function and a second function.

11. The system of claim 10, wherein the first function is capable of being reset while the second function remains operational.

12. The system of claim 9, further comprising a processor coupled to the root port.

13. The system of claim 12, further comprising memory coupled to the processor.

14. An article of manufacture comprising a machine-accessible medium having stored thereon instructions which, when executed by a machine, cause the machine to:
identify a function of an I/O device to be reset;
stop incoming and outgoing transactions for the function;
set a bit to initiate a reset of the function;
send a configuration space request to the function; and
transition the function into an uninitialized state.

15. The article of manufacture of claim 14, wherein the function is the only function of the I/O device.

16. The article of manufacture of claim 14, wherein the function is one of a plurality of functions of the I/O device.

17. The article of manufacture of claim 14, wherein the bit is in a configuration space.

18. The article of manufacture of claim 14, wherein the instructions further cause the machine to transition the function into an initialized state.

19. A method comprising:
determining that a first device in a system requires a reset;
initiating the reset of the first device; and
transitioning the first device from a current state to a functional level reset (FLR) state, wherein a second device in the system remains operational while the first device changes states.

20. The method of claim 19, further comprising transitioning the first device from the functional level reset state to an uninitialized state, wherein the second device remains operational while the first device changes states.

21. The method of claim 20, further comprising transitioning the first device from the uninitialized state to an initialized state, wherein the second device remains operational while the first device changes states.

22. The method of claim 20, wherein transitioning the first device from the functional level reset state to the uninitialized state occurs less then 100 ms after transitioning the first device from the current state to the functional level reset (FLR) state.

23. The method of claim 22, further comprising issuing a configuration space request prior to transitioning the first device from the functional level reset state to the uninitialized state.

24. The method of claim 19, wherein the current state is one of an uninitialized state, an initialized state, a D1 state, a D2 state, or a D3 hot state.

25. An apparatus comprising:
a first peripheral component interconnect (PCI) function; and
a second PCI function, wherein the first PCI function is capable of being reset while the second PCI function remains operational.

26. The apparatus of claim 25, wherein the apparatus further comprises control circuitry to allow the first and second PCI functions to transmit and receive commands and data.

27. The apparatus of claim 26, wherein the first PCI function has one or more registers that are capable of being reset during a functional level reset operation and one or more registers that are not capable of being reset during the functional level reset operation.
